(19) United States
(12) Patent Application Publication
(10) Pub. No.: US 2008/0309757 A1
(43) Pub. Date: Dec. 18, 2008

(54) AUDIO-VIDEO PLAYING SYSTEM CAPABLE OF DETECTING REMOTE CONTROL DISTANCE AND METHOD THEREOF

(75) Inventors: Chih-Cheng WAN, Taipei (TW); Jing-Rung Wang, Taipei (TW)

Correspondence Address: Muncy, Geissler, Olds & Lowe, PLLC, P.O. BOX 1364, FAIRFAX, VA, 22038-1364, US

(73) Assignee: ASUSTeK COMPUTER INC.

(21) Appl. No.: 12/129,267

(22) Filed: May 29, 2008

(30) Foreign Application Priority Data
Jun. 14, 2007 (TW) 096121564

(51) Int. Cl. H04N 9/00

(52) U.S. Cl. 348/61; 348/E09.001

(57) ABSTRACT

An audio-video playing system capable of detecting a remote control distance includes a remote control device and an audio-video playing device. The remote control device has a transmitting unit, a first control unit, and an input interface. When the input interface is enabled, the first control unit controls the transmitting unit to transmit a signal. The audio-video playing device has a receiving unit and a second control unit electrically connected to the receiving unit. The receiving unit receives the signal. The second control unit calculates a distance value of a distance between the remote control device and the audio-video playing device according to the signal. In addition, an audio-video playing method capable of detecting a remote control distance is also provided.

### CROSS REFERENCE TO RELATED APPLICATIONS

This Non-provisional application claims priority under 35 U.S.C. §119(a) on Patent Application No(s). 096121564 filed in Taiwan, Republic of China on Jun. 14, 2007, the entire contents of which are hereby incorporated by reference.

### BACKGROUND OF THE INVENTION

1. Field of Invention

The invention relates to a playing system and a method thereof and, more particularly, to an audio-video playing system capable of detecting a remote control distance and a method thereof.

2. Related Art

Along with the progress of the science and technology and the popularity of electronic products, an audio-video playing device becomes one of important consumption electronic products. A common audio-video playing device transmits radiant rays, and therefore, a user has to use the audio-video playing device at a sufficient safety distance to meet safety consideration.

As shown in FIG. 1, a conventional audio-video playing device 11 having a warning function for a safety distance includes a display unit 111, an infrared detection unit 112 and a loudspeaker 113. When the display unit 111 is turned on, the infrared detection unit 112 can continuously detect whether a person exists within a safety watching distance D₁₁ in front of the display unit 111.

As shown in FIG. 2, if a person P₁₁, watches a program displayed by the display unit 111 within the safety watching distance D₁₁, the infrared detection unit 112 can detect the existence of the person P₁₁, and the loudspeaker 113 can send out a sound to warn the person P₁₁ to watch the program at a watching distance which is larger than the safety watching distance D₁₁.

The infrared detection unit 112 continuously detects after the display unit 111 is turned on, and therefore, the power is consumed, and the infrared detection unit 112 is easy to be damaged because of frequent usage. If other persons who do not watch the program pass through the front of the display unit 111, the infrared detection unit 112 also detects the existence of the persons, and then, the loudspeaker 113 sends out a voice to warn, which disturbs the person watching the program.

### SUMMARY OF THE INVENTION

The objective of the invention is to provide an audio-video playing system capable of detecting a remote control distance and a method thereof to detect whether a person exists outside a safety distance. The audio-video playing system saves power consumption, and it is not easy to be disturbed by other persons who do not watch a program.

To achieve the above objective, an audio-video playing system capable of detecting a remote control distance of the invention includes a remote control device and an audio-video playing device. The remote control device has a transmitting unit, a first control unit and an input interface. When the input interface is enabled, the first control unit controls the transmitting unit to transmit a signal. The audio-video device has a receiving unit and a second control unit electrically connected to the receiving unit. The receiving unit receives the signal, and the second control unit calculates a distance value of a distance between the remote control device and the audio-video playing device.

To achieve the above objective, an audio-video playing method capable of detecting a remote control distance of the invention is cooperated with a remote control device and an audio-video playing device. The audio-video playing method capable of detecting the remote control distance includes the following steps. First, an information generated by enabling an input interface is received. Then, the remote control device transmits a signal. Next, the audio-video playing device receives the signal. Finally, a distance value of a distance between the remote control device and the audio-video playing device is calculated out according to the signal.

From the above, according to an audio-video playing system capable of detecting a remote control distance and a method thereof, when the input interface is enabled, the first control unit controls the transmitting unit to transmit a signal. The receiving unit receives the signal to allow the second control unit to calculate the distance value of the distance between the remote control device and the audio-video playing device. In other words, when a person watching a program touches, operates or presses the input interface to enable the input interface, the transmitting unit can transmit a signal. Therefore, the transmitting unit does not need to continuously transmit signals. Thus, the power is saved, and the lifespan of the transmitting unit is prolonged.

Only when the person using the audio-video playing device touches, operates or presses the input interface to enable the input interface, the transmitting unit can transmit the signal. Therefore, the audio-video playing system is not easy to be disturbed by persons who do not use the audio-video playing device.

### BRIEF DESCRIPTION OF THE DRAWINGS

The invention will become more fully understood from the detailed description and accompanying drawings, which are given for illustration only, and thus are not limitative of the present invention, and wherein:

FIG. 1 and FIG. 2 are schematic diagrams showing a conventional audio-video playing device;

FIG. 3 is a schematic diagram showing an audio-video playing system capable of detecting a remote control distance according to a preferred embodiment of the invention;

FIG. 4, FIG. 5 and FIG. 6 are block diagrams showing an audio-video playing system capable of detecting a remote control distance according to a preferred embodiment of the invention;

FIG. 7 is a schematic diagram showing an audio-video playing system capable of detecting a remote control distance according to another preferred embodiment of the invention;

FIG. 8 is a block diagram showing an audio-video playing system capable of detecting a remote control distance according to another preferred embodiment of the invention;

FIG. 9 is a flow chart showing an audio-video playing method capable of detecting a remote control distance according to a preferred embodiment of the invention; and

FIG. 10 is a flow chart showing another audio-video playing method capable of detecting a remote control distance according to a preferred embodiment of the invention.

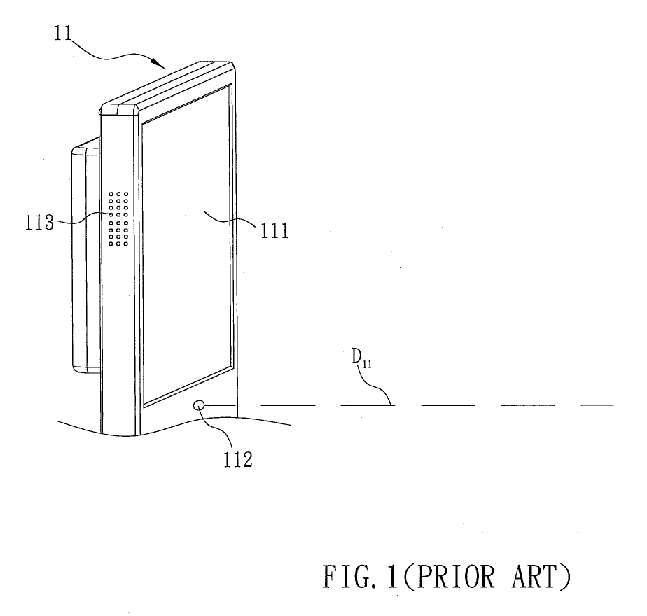

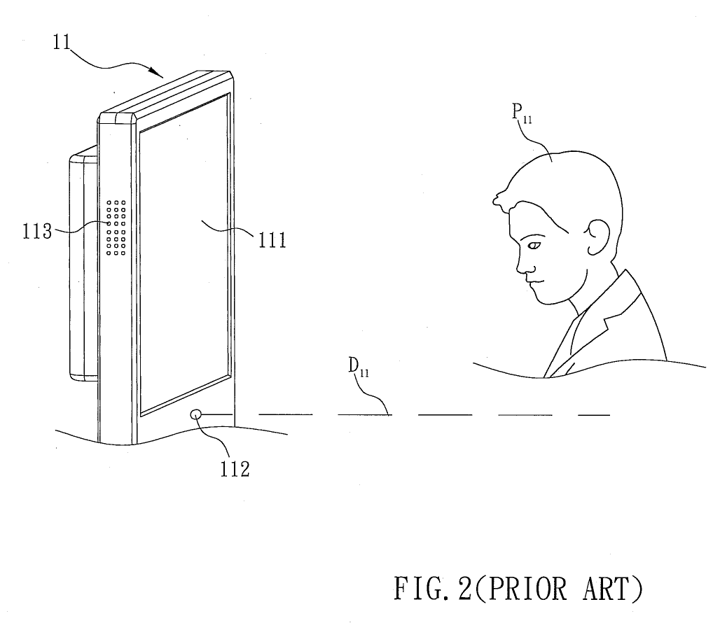

### DETAILED DESCRIPTION OF THE INVENTION

The present invention will be apparent from the following detailed description, which proceeds with reference to the accompanying drawings, wherein the same references relate to the same elements.

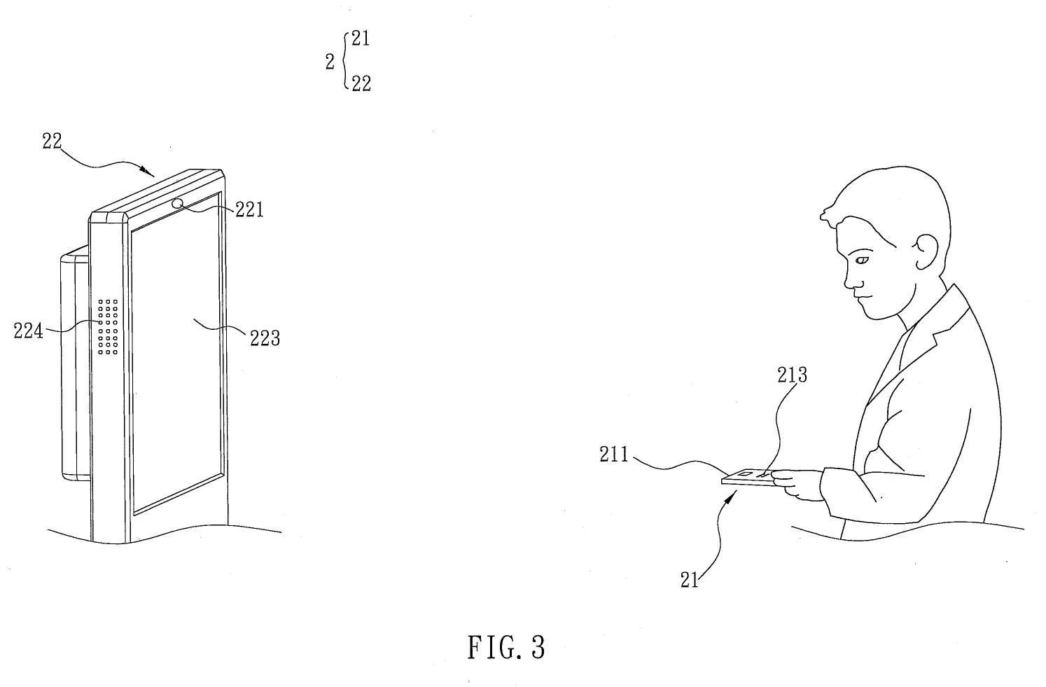

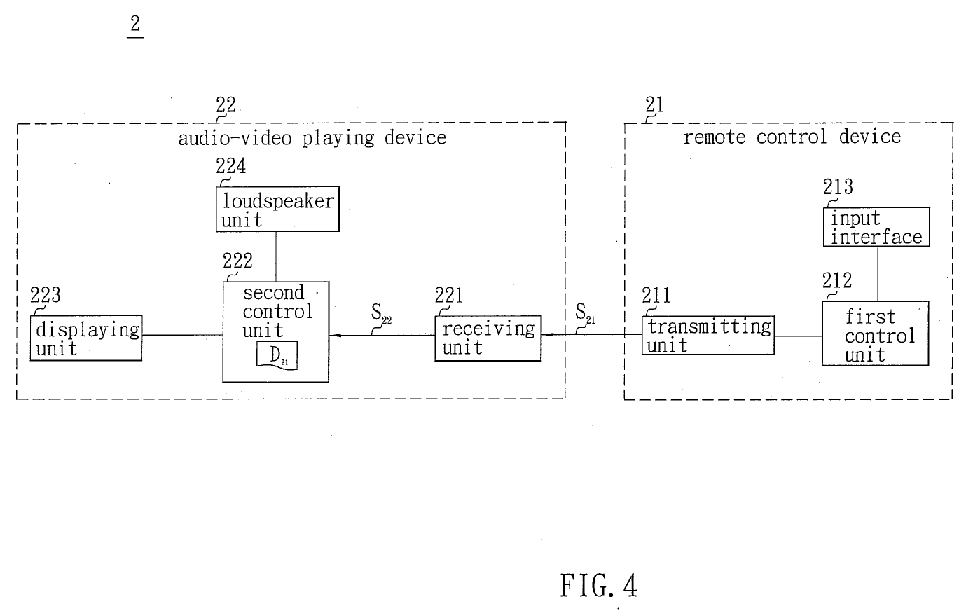

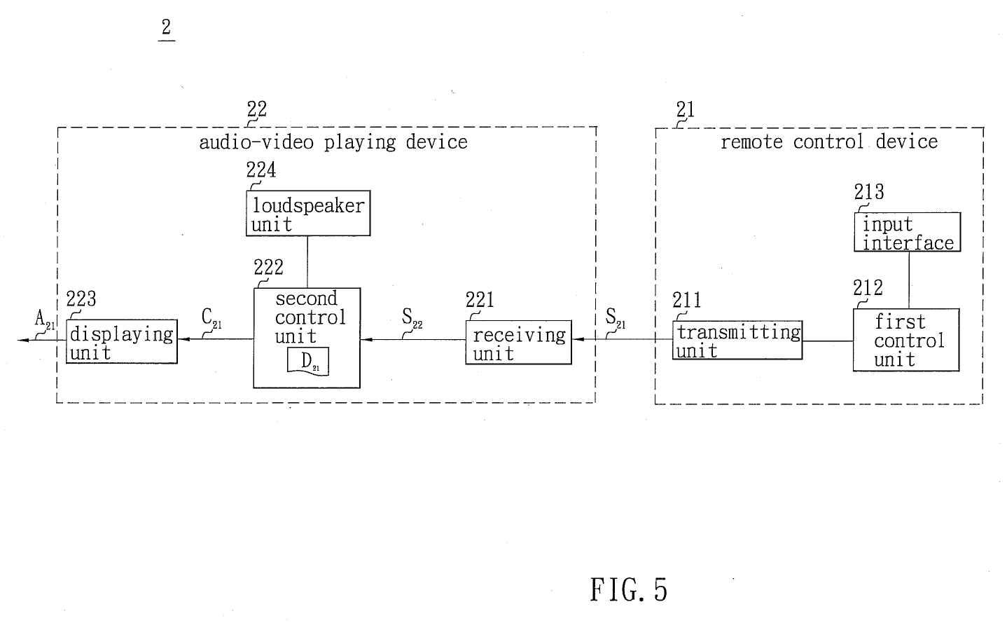

As shown in FIG. 3 and FIG. 4, according to the preferred embodiment of the invention, an audio-video playing system 2 is capable of detecting a remote control distance includes a remote control device 21 and an audio-video playing device 22. The audio-video playing device 22 may be a television, a stereo, and it is not limited. The remote control device 21 may be a wired or wireless remote control device.

In the embodiment, the remote control device 21 has a transmitting unit 211, a first control unit 212 and an input interface 213. The first control unit 212 is electrically connected to the transmitting unit 211 and the input interface 213, respectively. When the input interface 213 is enabled, the first control unit 212 controls the transmitting unit 211 to transmit a signal S₂₁.

Herein, the input interface 213 can be designed according to actual requirements. For example, the input interface 213 may be a touch panel, a joystick, a button, a key and so on. A user can touch, operate or press the input interface 213 to enable the input interface 213.

In the embodiment, the transmitting unit 211 may be a light transmitter for transmitting light with a wavelength within a specific scope, but it is not limited. The first control unit 212 may be a micro controller unit (MCU), but it is not limited.

The audio-video playing device 22 of the embodiment includes a receiving unit 221, a second control unit 222, a display unit 223 and a loudspeaker unit 224. The second control unit 222 is electrically connected to the receiving unit 221, the display unit 223 and the loudspeaker unit 224, respectively.

As shown in FIG. 4, the receiving unit 221 receives the signal S₂₁ (such as a light wave signal) and converts the signal S₂₁ to a signal S₂₂ (such as an electrical signal). The second control unit 222 calculates a distance value D₂₁ of a distance between the remote control device 21 and the audio-video playing device 22 according to the signal S₂₂. If the transmitting unit 211 is a light transmitter for transmitting light with wavelength within a specific scope, the receiving unit 221 may be at least a charge coupled device (CCD) or at least a complementary metal-oxide semiconductor (CMOS) to receive the light wave signal S₂₁ and convert the light wave signal S₂₁ to the electrical signal S₂₂. Then, the second control unit 222 calculates out the distance value D₂₁ of the distance between the remote control device 21 and the audio-video playing device 22 according to the electrical signal S₂₂. In the embodiment, the second control unit 222 can be designed via software or hardware.

Therefore, after the second control unit 222 calculates out the distance value D₂₁ of the distance between the remote control device 21 and the audio-video playing device 22, the distance value D₂₁ of the distance can be used in the following steps. For example, the second control unit 222 allows the display unit 223 to display the distance value D₂₁, or the second control unit 222 changes the brightness of the display unit 223 according to the distance value D₂₁.

As shown in FIG. 5, the second control unit 222 can determine whether the distance value D₂₁ is less than a reference value. The reference value may be a safety watching distance. When the distance value D₂₁ is less than the reference value, the second control unit 222 can generate a warning command C₂₁ The display unit 223 can display a warning information A₂₁ according to the warning command C₂₁ to prompt a person to watch a program at a watching distance which is larger than the safety watching distance (the reference value).

As shown in FIG. 6, when the distance value D₂₁ is less than the reference value, the second control unit 222 can also generate a warning command C₂₂. The loudspeaker unit 224 sends out a warning information A₂₂ according to the warning command C₂₂ to prompt the person to watch the program at a watching distance which is larger than a safety watching distance (the reference value).

From the above, according to the audio-video playing system 2 capable of detecting the remote control distance of the embodiment, when the input interface 213 is enabled, the first control unit 212 controls the transmitting unit 211 to transmit the signal S₂₁. It allows the audio-video playing device 2 to calculate out the distance value D₂₁ of the distance between the remote control device 21 and the audio-video playing device 22 according to the signal S₂₁. In other words, only when the person watching the program touches, operates or presses the input interface 213 to enable the input interface 213, the transmitting unit 211 can transmit the signal S₂₁, and then the transmitting unit 211 does not need to continuously transmit signals. Thus, the power is saved, and the lifespan of the transmitting unit is prolonged.

Only when the person watching the program touches, operates or presses the input interface 213 to enable the input interface 213, the transmitting unit 211 can transmit the signal S₂₁. Therefore, the audio-video playing system is not easy to be disturbed by other persons who do not watch the program.

The audio-video playing device can also perform an audio-video information by play, fast forward, reverse, pause, stop, and volume increase or volume decrease according to the signal S₂₂. For example, when a user operates the input interface 213, the second control unit 222 of the audio-video playing device 22 can not only calculate the distance value D₂₁, but control the display unit 223 and the loudspeaker unit 224 to begin to play audio-video information.

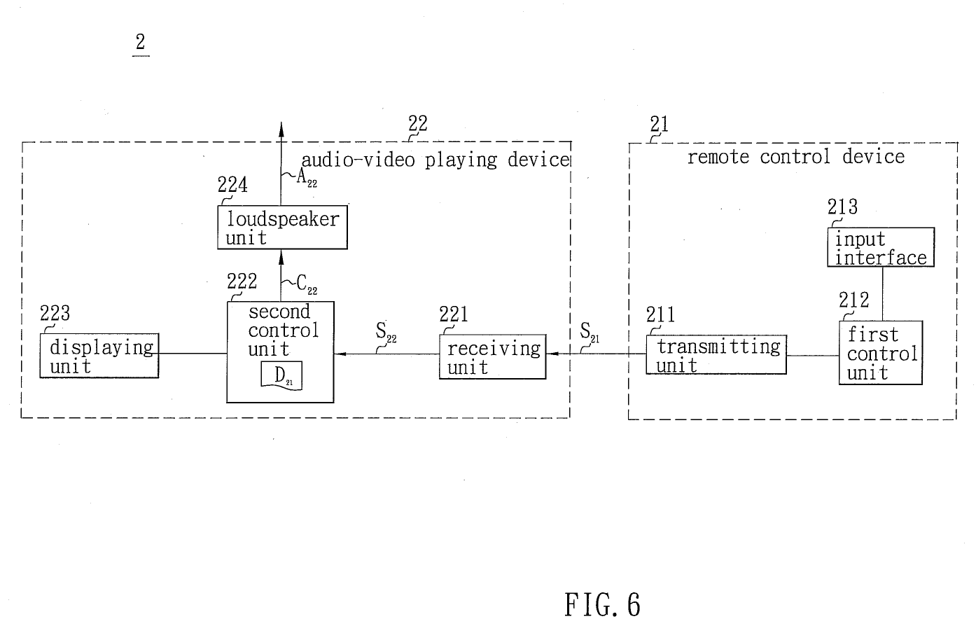

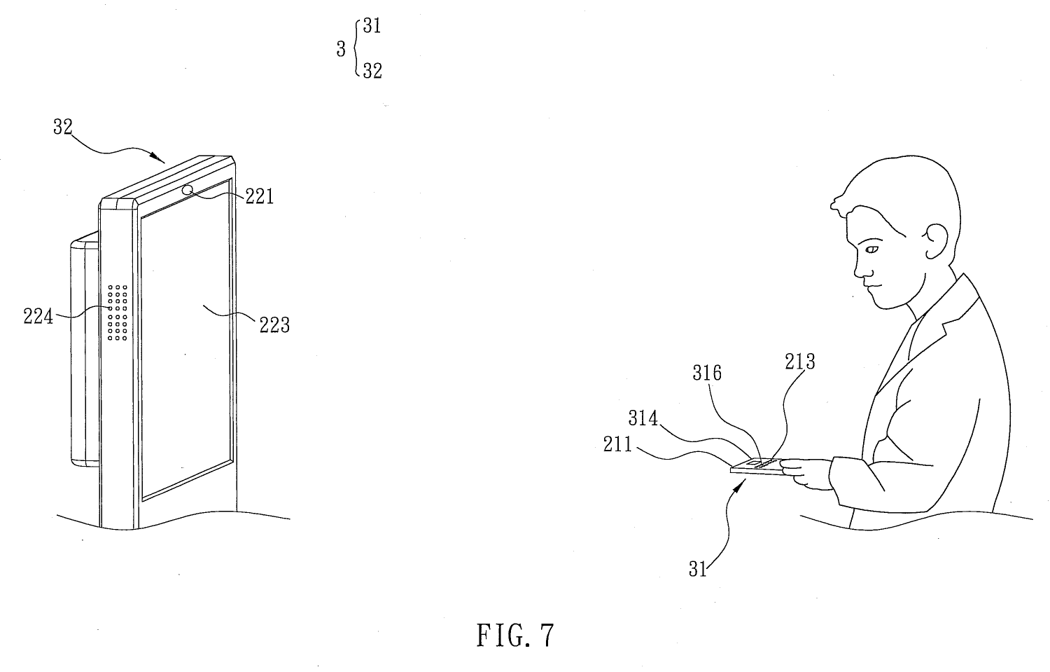

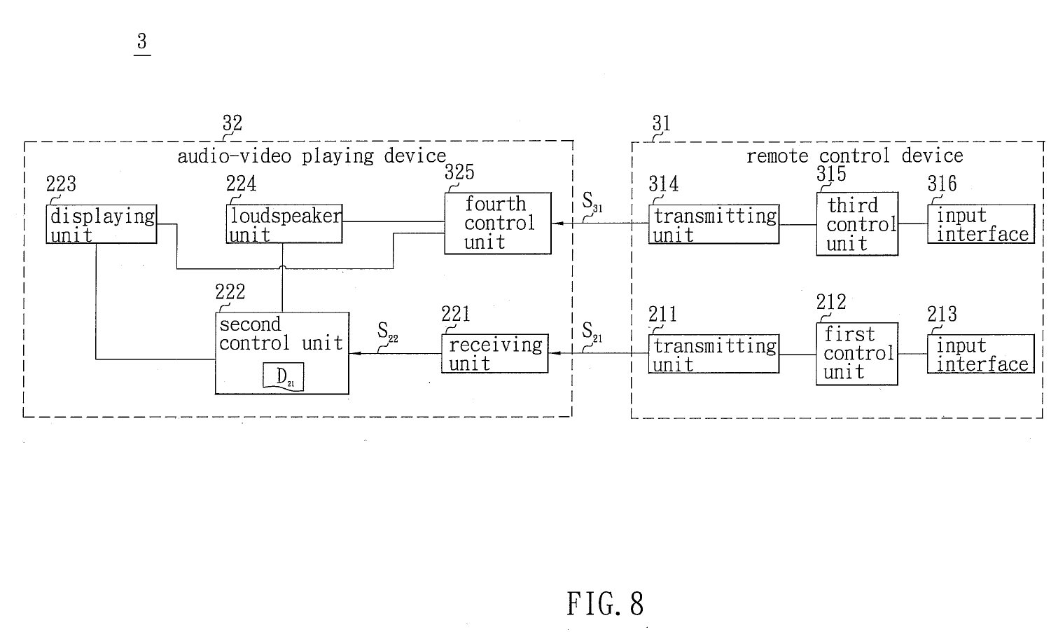

As shown in FIG. 7 and FIG. 8, an audio-video playing system 3 capable of detecting a remote control distance of another preferred embodiment of the invention includes a remote control device 31 and an audio-video playing device 32. The remote control device 31 further includes another transmitting unit 314, a third control unit 315 and another input interface 316 besides the transmitting unit 211, the first control unit 212 and the input interface 213. The audio-video playing device 32 further includes a fourth control unit 325 besides the receiving unit 221, the second control unit 222, the display unit 223 and the loudspeaker unit 224.

The another input interface 316 can be designed according to actual requirements. For example, the another input interface 316 may be a touch panel, a joystick, a button, a key and so on. A user can touch, operate or press the another input interface 316 to enable the another input interface 316.

When the another input interface 316 is enabled, the third control unit 315 controls the transmitting unit 314 to transmit another signal S₃₁. The fourth control unit 325 of the audio-video playing device 32 controls the display unit 223 or the loudspeaker unit 224 to perform an audio-video information by play, fast forward, reverse, pause, stop, and volume increase or volume decrease according to the another signal S₃₁.

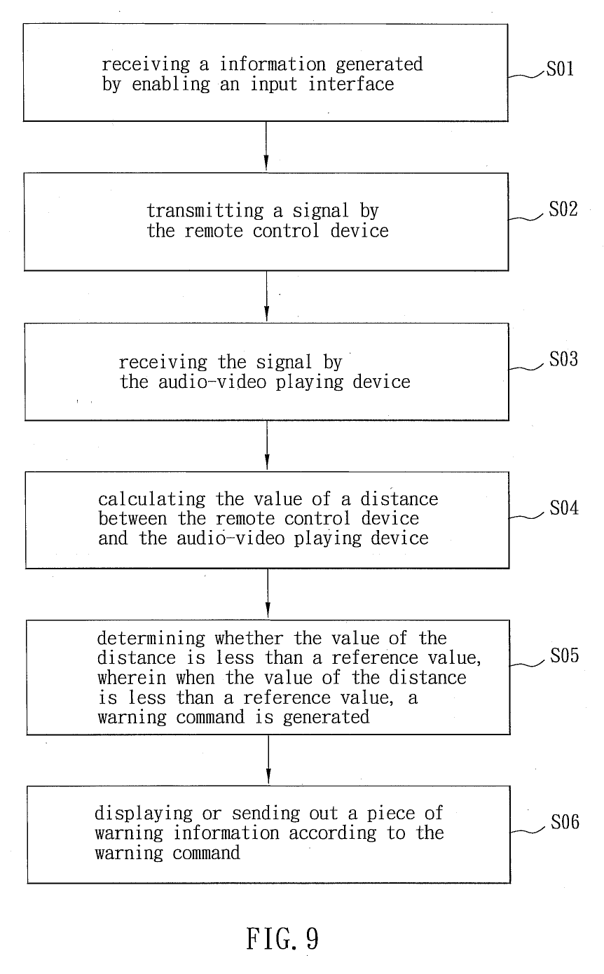

As shown in FIG. 9, an audio-video playing method capable of detecting a remote control distance of a preferred embodiment of the invention is cooperated with a remote control device and an audio-video playing device. The audio-video playing method capable of detecting the remote control distance includes the following steps S01 to S04.

In the step S01, an information generated by enabling an input interface is received.

In the step S02, the remote control device transmits a signal.

In the step S03, the audio-video playing device receives the signal.

In the step S04, a distance value of a distance between the remote control device and the audio-video playing device is calculated out.

The audio-video playing method capable of detecting the remote control distance further includes the steps S05 to S06.

In the step S05, whether the distance value is less than a reference value is determined. When the distance value is less than the reference value, a warning command is generated.

In the step S06, a warning information according to the warning command is displayed or transmitted.

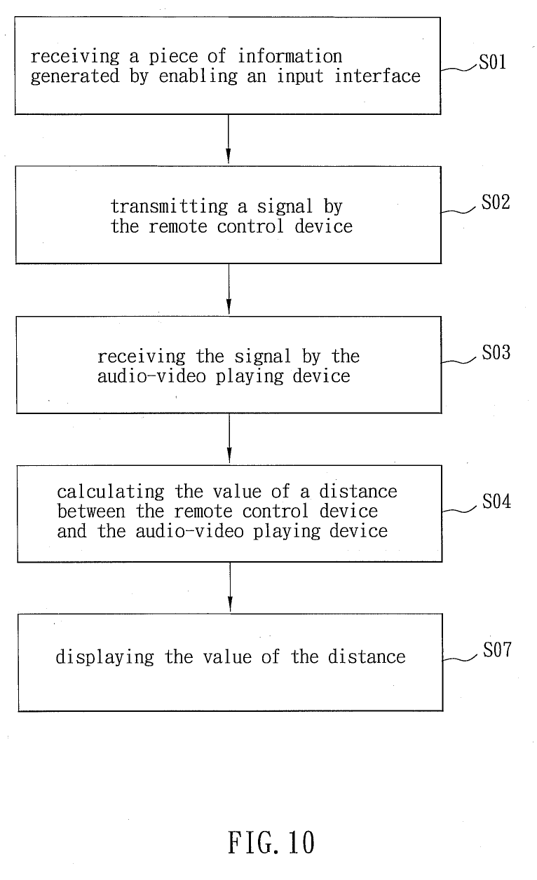

As shown in FIG. 10, after the step S04 is finished, the step S07 may be executed.

In the step S07, the distance value is displayed.

The audio-video playing method capable of detecting the remote control distance of the embodiment is described in the above content for describing the audio-video playing system 2 capable of detecting the remote control distance of the first embodiment and the audio-video playing system 3 capable of detecting the remote control distance of the second embodiment, and it is not described for concise purpose.

To sum up, according to the audio-video playing system capable of detecting the remote control distance and the method thereof, when the input interface is enabled, the first control unit controls the transmitting unit to transmit the signal. It allows the second control unit to calculate the distance value of the distance between the remote control device and the audio-video playing device according to the signal. In other words, when the person watching a program touches, operates or presses the input interface to enable the input interface, the transmitting unit can transmit the signal. Therefore, the transmitting unit does not need to continuously transmit signals. Thus, the power is saved, and the lifespan of the transmitting unit increases.

When the person watching the program touches, operates or presses the input interface to enable the input interface, the transmitting unit can transmit the signal. Therefore, the audio-video playing system is not easy to be disturbed by other persons who do not watch the program.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An audio-video playing system capable of detecting a remote control distance, the audio-video playing system comprising:
a remote control device having a transmitting unit, a first control unit and an input interface, wherein the first control unit is electrically connected to the transmitting unit and the input interface, respectively, and when the input interface is enabled, the first control unit controls the transmitting unit to transmit a signal; and
an audio-video playing device having a receiving unit and a second control unit electrically connected to the receiving unit, wherein the receiving unit receives the signal, and the second control unit calculates out a distance value of a distance between the remote control device and the audio-video playing device according to the signal.

2. The audio-video playing system capable of detecting the remote control distance according to claim 1, wherein the second control unit determines whether the distance value is less than a reference value, and when the second control unit determines that the distance value is less than the reference value, it generates a warning command.

3. The audio-video playing system capable of detecting the remote control distance according to claim 2, wherein the audio-video playing device further comprises a display unit, and the display unit displays a warning information according to the warning command.

4. The audio-video playing system capable of detecting the remote control distance according to claim 2, wherein the audio-video device further comprises a loudspeaker unit, and the loudspeaker unit sends out a warning information according to the warning command.

5. The audio-video playing system capable of detecting the remote control distance according to claim 1, wherein the audio-video playing device further comprises a display unit, and the display unit displays the distance value.

6. The audio-video playing system capable of detecting the remote control distance according to claim 1, wherein the remote control device further comprises an another input interface, and when the another input interface is enabled, the first control unit controls the transmitting unit to transmit an another signal.

7. The audio-video playing system capable of detecting the remote control distance according to claim 6, wherein the audio-video playing device performs an audio-video information by play, fast forward, reverse, pause, stop, and volume increase or volume decrease according to the another signal.

8. An audio-video playing method capable of detecting a remote control distance, wherein the audio-video playing method is cooperated with a remote control device and an audio-video playing device, the audio-video playing method comprising the steps of:
receiving an information generated by enabling an input interface;
transmitting a signal by the remote control device;
receiving the signal by the audio-video playing device; and
calculating a distance value of a distance between the remote control device and the audio-video playing device according to the signal.

9. The audio-video playing method capable of detecting the remote control distance according to claim 8 further comprising the step of:
determining whether the distance value is less than a reference value, wherein when the distance value is less than a reference value, a warning command is generated.

10. The audio-video playing method capable of detecting the remote control distance according to claim 9 further comprising the step of:
displaying or sending out a warning information according to the warning command.

11. The audio-video playing method capable of detecting the remote control distance according to claim 8 further comprising the step of:
displaying the distance value.
